(19) United States
(12) Patent Application Publication
(10) Pub. No.: US 2006/0057871 A1
(43) Pub. Date: Mar. 16, 2006

(54) Grounding element

(75) Inventor: Chun-Jung Tsuo, Taoyuan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/209,690

(22) Filed: Aug. 24, 2005

(30) Foreign Application Priority Data
Sep. 15, 2004 (TW) 93127847

(51) Int. Cl. H01R 4/66

(52) U.S. Cl. 439/92

(57) ABSTRACT

A grounding element attached to a tab having a hole. A spring portion is connected to one side of a bottom of the grounding element and extends in a first direction, and a latching portion is connected to another side of the bottom. When the grounding element is attached to the tab, the spring portion and the latching portion hold edges of the tab.

### BACKGROUND

The invention relates to a grounding element for an electronic device.

Typically, in an electronic device, a circuit board is grounded by electrically connecting the circuit board to a metal housing of the electronic device. The electrical connection is typically achieved by a metal grounding element. In FIG. 1, a conventional grounding element 100 is attached to a metal housing 10 of an electronic device. A tab 12 with a hole 14 on which the grounding element 100 is attached extends from the metal housing 10. A circuit board (not shown) is electrically connected to the metal housing 10 via the grounding element 100.

FIG. 2 depicts the structure of the conventional grounding element 100. The grounding element 100, formed by bending a metal plate, comprises a spring portion 110 and a bottom 120. The bottom 120 is planar. When the grounding element 100 is attached to the tab 12, the bottom 120 abuts the tab 12, and the spring portion 110 expands to abut the front of circuit board thereby maintaining a reliable electrical connection.

A protrusion 130 is further disposed on the bottom 120 and comprises an inclined surface 132 and an opening 134 adjacent to the inclined surface 132 and the bottom 120. When the grounding element 100 is attached to the tab 12 in the direction indicated by arrow A, the inclined surface 132 allows the protrusion 130 to be easily inserted into the hole 14, and edges of the opening 134 abut an inner wall of the hole 14 to prevent separation of the grounding element 100.

Although the protrusion 130 prevents separation of the grounding element 100, the protrusion 130 can still easily escape from the hole 14 causing separation of the grounding element 100 when the spring portion. 110 deformed in the direction indicated by arrow B.

### SUMMARY

A grounding element according to an embodiment of the invention comprises a bottom, a spring portion connected to one side of the bottom extending in a first direction, and a latching portion connected to another side of the bottom, wherein when the grounding element is assembled on a tab of a metal hiusing, the spring portion and the latching portion hold edges of the tab.

### BRIEF DESCRIPTION OF THE DRAWINGS

The invention can be more fully understood by reading the subsequent detailed description and examples with references made to the accompanying drawings, wherein:

FIG. 1 is a perspective view depicting a conventional grounding element attached to a housing of an electronic device;

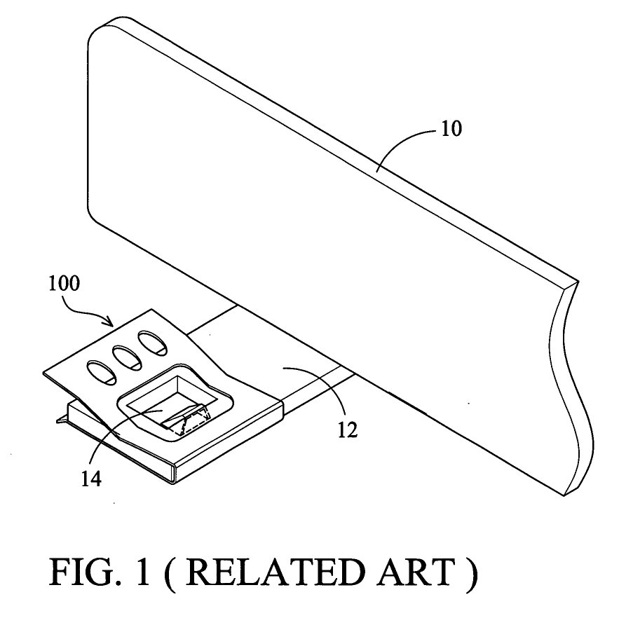

FIG. 2 is a perspective view of a conventional grounding element;

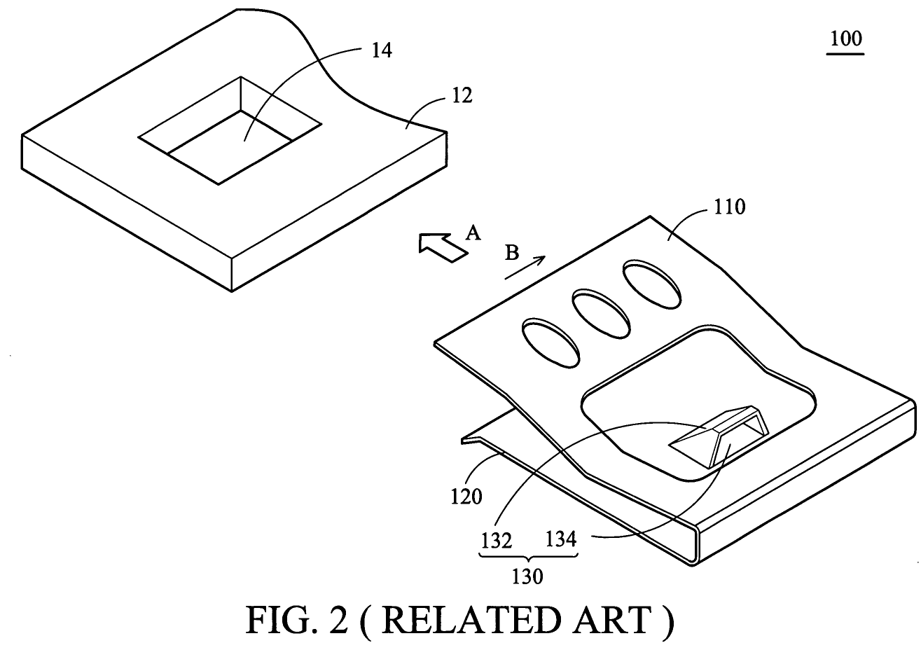

FIG. 3 is a perspective view depicting a grounding element according to an embodiment of the invention attached to a housing of an electronic device;

FIG. 4 is a perspective view of a grounding element according to an embodiment of the invention; and

FIG. 5 is a cross section of FIG. 3 along line a-a.

### DETAILED DESCRIPTION

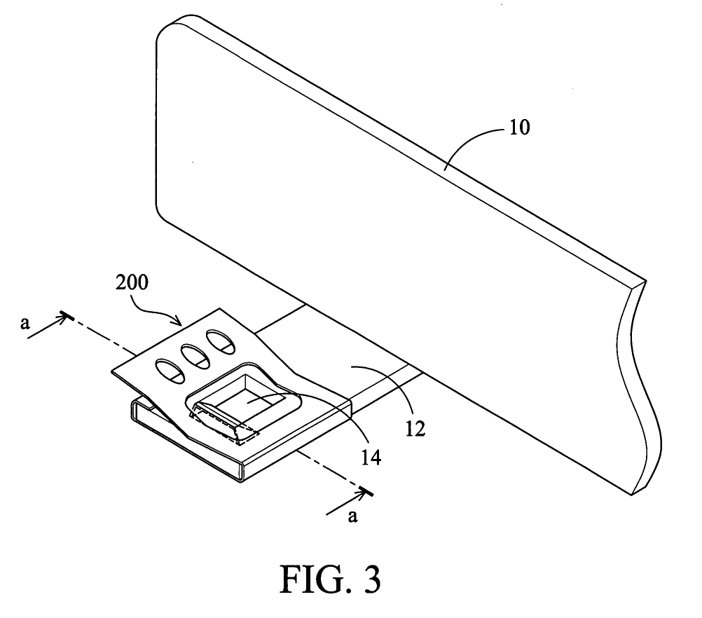

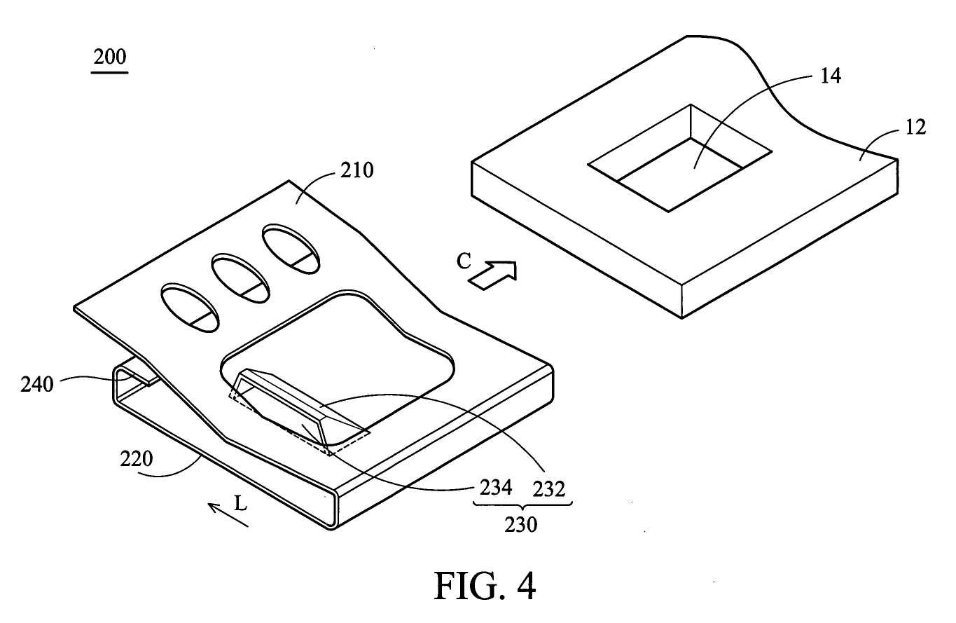

Referring to FIG. 3, a grounding element 200 is attached to a tab 12 of a metal housing 10. In FIG. 4, the grounding element 200 comprises a spring portion 210, a bottom 220 and a latching portion 240. The spring portion 210 is connected to one side of the bottom 220 and substantially extends in a first direction L. The latching portion is connected to another side of bottom 220. In this embodiment, the latching portion 240 and the bottom 220 are configured in a U shape. The grounding element 200 further comprises a protrusion 230 including an inclined surface 232 and an opening 234 adjacent to the inclined surface 232 and the bottom 220. The opening 234 is perpendicular to the first direction L.

When the grounding element 200 is attached to the tab 12 in the direction indicated by arrow C, the inclined surface 232 allows easy insertion of the protrusion 230 into the hole 14, and edges of the opening 234 abut an inner wall of the hole 14 preventing separation of the grounding element 200. The spring portion 210 and latching portion 240 hold edges of the tab 12, thus, even if the spring portion 210 is pulled and deformed, the latching portion 240 will still hold the tab 12. As the opening 234 abuts the hole 14 in a direction opposite to that indicated by arrow C, the grounding element 200 is held on the tab 12.

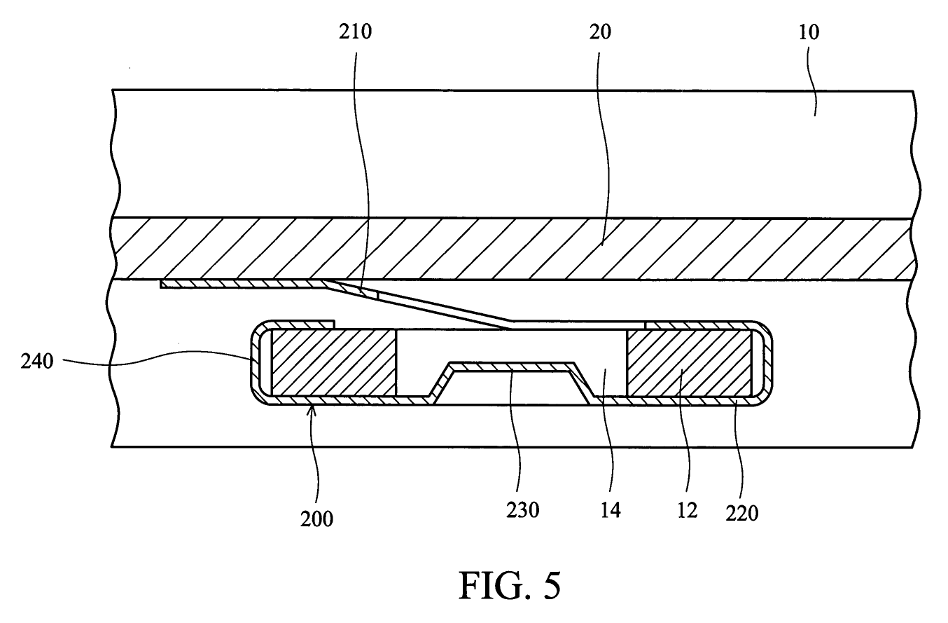

In FIG. 5, a circuit board 20 is electrically connected to the metal housing 10 via the grounding element 200.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A grounding element attached to a tab having a hole, comprising:
a bottom;
a spring portion connected to one side of the bottom and extending in a first direction; and
a latching portion connected to another side of the bottom, wherein when the grounding element is assembled on the tab, the spring portion and the latching portion hold edges of the tab.

2. The grounding element as claimed in claim 1, wherein the latching portion connected to the bottom is configured in a U shape.

3. The grounding element as claimed in claim 1, wherein spring portion, the latching portion and the bottom are integrally formed.

4. The grounding element as claimed in claim 1 further comprising a protrusion on the bottom, wherein when the grounding element is assembled to the tab, the protrusion is inserted into the hole.

5. The grounding element as claimed in claim 4, wherein the protrusion comprises an opening adjacent to the bottom and perpendicular to the first direction, and when the grounding element is attached to the tab, edges of the opening abut an inner wall of the hole.
